(19) United States
(12) Patent Application Publication
(10) Pub. No.: US 2004/0156347 A1
(43) Pub. Date: Aug. 12, 2004

(54) Handover method and apparatus in WLAN environment

(75) Inventor: Pyung-soo Kim, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/747,213

(22) Filed: Dec. 30, 2003

(30) Foreign Application Priority Data
Dec. 31, 2002 (KR) 2002-87938

(51) Int. Cl. H04Q 7/24

(52) U.S. Cl. 370/338; 370/331

(57) ABSTRACT

Provided are a handover method and apparatus in a WLAN environment and an ICMP message used in such a WLAN environment. The handover method involves a) issuing a request for distributed information table (DIT) information, which is network information on access routers, to an access router of a Basic Service Set that a mobile node belongs to when booted; b) receiving DIT information from the access router and storing the received DIT information; and c) performing binding update using the stored DIT information.

### BACKGROUND OF THE INVENTION

This application claims the priority of Korean Patent Application No. 2002-87938, filed on Dec. 31, 2002, in the Korean Intellectual Property Office, the disclosure of which is incorporated herein in its entirety by reference.

1. Field of the Invention

Apparatuses and methods consistent with the present invention relate to a handover method and apparatus in a wireless local area network (WLAN) environment and an Internet control message protocol (ICMP) message used in a WLAN environment.

2. Description of the Related Art

The Internet has become one of the most important information infrastructures of an information society that we are living in. In accordance with the advent of the Internet, the numbers of Internet users and Internet-associated equipment have been rapidly increasing. Against this backdrop, Internet Protocol Version 6 (IPv6), which aims at solving IP address shortages and guaranteeing routing efficiency, mobility, and quality-of-service (QoS), has been developed and is now expected to be commercialized in the near future.

In addition, mobile IPv6, which can more reliably and more efficiently guarantee mobility while providing typical IPv6 functions, has been developed. However, in order to enable seamless mobile communications, a handover process on Layer 3 (IP layer) is essential.

Recently, an Internet-Draft of the Internet Engineering Task Force (IETF) entitled, “Fast Handovers for Mobile IPv6,” has been suggested. The Internet-Draft presents an algorithm capable of carrying out a quick handover with the help of Layer 2 (link layer).

A mobile IP presents an explanation of necessary protocol operations for maintaining a mobile node's connection to the Internet during a handover process in which the mobile node is disconnected from one access router and then is handed over to another access router. The necessary protocol operations include detecting movements, creating an IP address, and updating a location.

In the meantime, a wireless local area network (WLAN) has a structure in which small networks called Basic Service Sets (BSSs) exist in a larger network called an extended service set (ESS). In each of the BSSs, access points exist for enabling interconnections among the BSSs. These access points share BSS identification (ID), which is a media access control (MAC) layer identifier, with one another. Currently, a mobile IP is only enabled within the ESS. Therefore, given the current level of WLAN technology, it is safe to say that communications between ESSs are impossible.

Hereinafter, a conventional handover process in a mobile IP will be described in greater detail with reference to FIG. 1.

An access router periodically generates a beacon signal for broadcasting its own ID, i.e., BSSID, over a mobile network. In other words, referring to FIG. 1, a previous access router (PAR) 120 and a new access router (NAR) 130 periodically generate a beacon signal. The PAR 120 is a default router of a mobile node 110 before a handover, and the NAR 130 is a default router of the mobile node 110 after the handover.

Let us assume that the PAR 120 and the NAR 130 create Basic Service Sets BSS1 and BSS2, respectively. Then, the mobile node 110 belongs to BSS1 until it moves. On the other hand, the mobile node 110 belongs to BSS2 after it moves. Even when the mobile node 110 belongs to BSS1, it can receive a beacon signal from the NAR 130. However, the received beacon signal is very weak. Likewise, when the mobile node 110 belongs to BSS2, it can receive a beacon signal from the PAR 120. However, the received beacon signal is very weak.

While the mobile node 110 moves from the BSS1 to BSS2, as shown in FIG. 1, there is a moment when the intensity of the beacon signal received from the NAR 130 becomes higher than the intensity of the beacon signal received from the PAR 120. At this moment, an L2 trigger occurs on an L2 layer. When the L2 trigger occurs, the mobile node 110 can identify BSSID of the NAR 130 based on the beacon signal received from the NAR 130.

Finally, the mobile node 110 performs a handover by issuing a request for information on the NAR 130 to the PAR 120 using the BSSID of the NAR 130, carrying out binding update, and enabling a handover initiation message and an ACK message to be transmitted between the PAR 120 and the NAR 130.

FIG. 2 is a flowchart of a conventional handover operation.

Referring to FIG. 2, an L2 trigger occurs in step S210. The occurrence of the L2 trigger means that a mobile node has just entered a new network. The mobile node can identify BSSID of an NAR.

In step S220, the mobile node issues a request for information on the NAR corresponding to the identified BSSID to a PAR by sending a Router Solicitation for Proxy (RtSolPr) message to the PAR.

In step S230, the PAR searches a distributed information table containing network information regarding all access routers in a current ESS. In step S240, the PAR transmits the requested information on the NAR, for example, prefix information, a link layer address, and an IP address, to the mobile node by sending a Proxy Router Advertisement (PrRtAdv) message to the mobile node.

In step S250, the mobile node creates a care-of-address (CoA) using its own MAC address and the prefix information of the NAR. In step S260, the mobile node sends a fast binding update message (FBU message) to the PAR.

In step S270, the PAR sends an acknowledgement (ACK) message to the mobile node in response to the reception of the quick binding update message.

In step S280, the PAR sends a handover initiation message (HI message) to the NAR. In step S290, the NAR sends an ACK message to the PAR in response to the reception of the handover initiation message.

Then, the entire handover operation is completed. If there is a packet to be transmitted to the mobile node during the handover operation, the packet is transmitted to the mobile node via the NAR. After the handover operation, the mobile node uses the NAR rather than the PAR.

However, the conventional handover method generally results in handover latency because it usually takes a while to carry out a handover operation in the prior art. Here, a period of time during which a mobile node is unable to receive or transmit packets over an IP layer due to a handover operation is referred to as the handover latency. Therefore, it is almost impossible to apply the conventional handover method to various fields, such as VoIP-based video telecommunications, video conferences, or moving picture transmissions, in which real-time communications are required.

In a small-sized WLAN environment where a network, comprised of BSSs, includes access routers and a handover operation is frequently carried out by many mobile nodes accessing the network, the conventional handover method may bring about a waste of time and resources.

In the meantime, Korean Patent Laid-open Publication No. 2001-87890, entitled “Fast Handover Method Using Beacon Message in WLAN,” discloses a handover technique in which an access router, to which a mobile node is to be handed over, periodically sends out a beacon message containing power intensity measurement information and prefix information and a user terminal that receives the beacon message creates an address using the prefix information and carries out a handover operation using the created address. In this technique, an NAR's prefix information is contained in a beacon message, and then the beacon message is transmitted to a user terminal. Therefore, the beacon message needs to be large enough to contain the NAR's prefix information.

### SUMMARY OF THE INVENTION

The present invention provides a handover method and apparatus, which are capable of handover latency in a small-sized WLAN environment, and an Internet control message protocol (ICMP) message used in such a WLAN environment.

According to an aspect of the present invention, there is provided a handover method in a wireless local area network (WLAN) environment. The handover method involves a) issuing a request for a distributed information table (DIT) information, which is network information on access routers, to an access router of a Basic Service Set that a mobile node belongs to when booted; b) receiving DIT information from the access router and storing the received DIT information; and c) performing binding update using the stored DIT information.

According to another aspect of the present invention, a handover apparatus in a WLAN environment is provided. The handover apparatus includes a DIT information requesting unit which issues a request for DIT information, which is network information on access routers, to an access router of a Basic Service Set that a mobile node belongs to when booted; a DIT information storage unit which stores DIT information received from the access router; and a binding update processing unit which carries out binding update using the stored DIT information.

According to another aspect of the present invention, there is provided an ICMP message used in a WLAN environment. The ICMP message includes a type field which indicates a request for DIT information on access routers of a Basic Service Set that the mobile node belongs to when booted.

According to another aspect of the present invention, there is provided an ICMP message used in a WLAN environment. The ICMP message includes a type field which indicates a response to a request for the DIT information; a number field which indicates the number of pieces of access router information to be transmitted; and an access router information field which indicates information on access routers.

In the present invention, some steps of a handover operation are carried out before rather than after an L2 trigger occurs on a layer 2. By doing so, the number of steps of the handover operation that need to be carried out after the L2 trigger occurs can be reduced.

In other words, information on an access router of a network that a mobile node accesses after being booted is obtained in advance by using an ICMP message. Then, a step of obtaining information on a next access router when a mobile node accesses a new network can be omitted, and thus handover latency can be reduced.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram illustrating a conventional handover method in a wireless local area network (WLAN) environment;

FIG. 2 is a flowchart of a conventional handover method in a WLAN environment;

FIG. 3 is a diagram illustrating a fast handover method in a WLAN environment according to an exemplary embodiment of the present invention;

FIG. 4 is a block diagram of a handover apparatus according to an exemplary embodiment of the present invention that carries out a handover for a mobile node in a WLAN environment;

FIG. 5 is a detailed block diagram of a DIT information storage unit of FIG. 4;

FIG. 6 is a flowchart of a handover method in a WLAN environment according to another exemplary embodiment of the present invention;

FIG. 7 is a diagram illustrating an example of an ICMP message according to an exemplary embodiment of the present invention, which is used by a mobile node to issue a request for DIT information; and

FIG. 8 is a diagram illustrating an example of an ICMP message according to another exemplary embodiment of the present invention, which is a response message created by an access router in response to a request for DIT information issued by a mobile node.

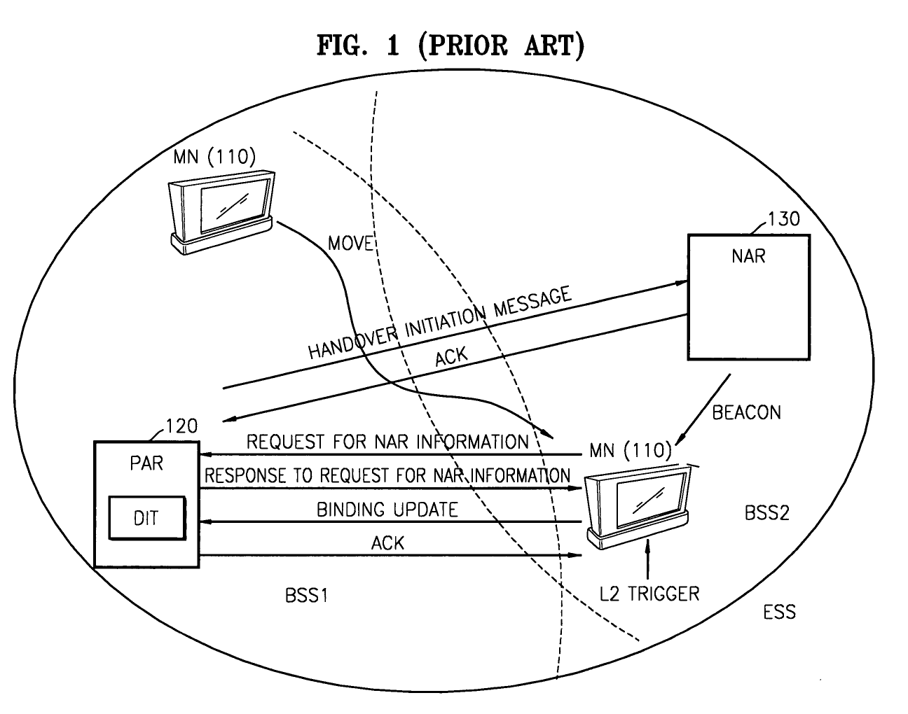

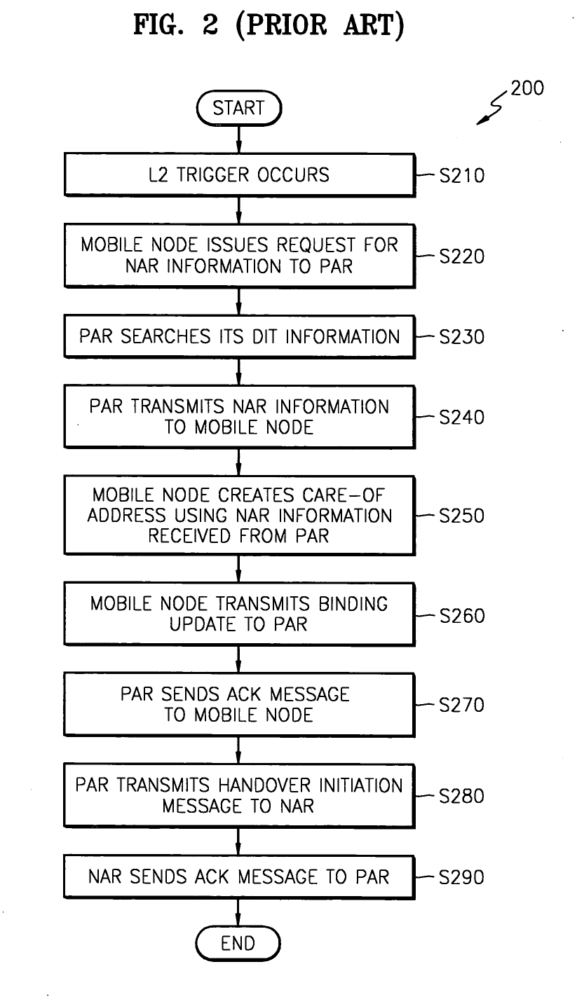

### DETAILED DESCRIPTION OF THE INVENTION

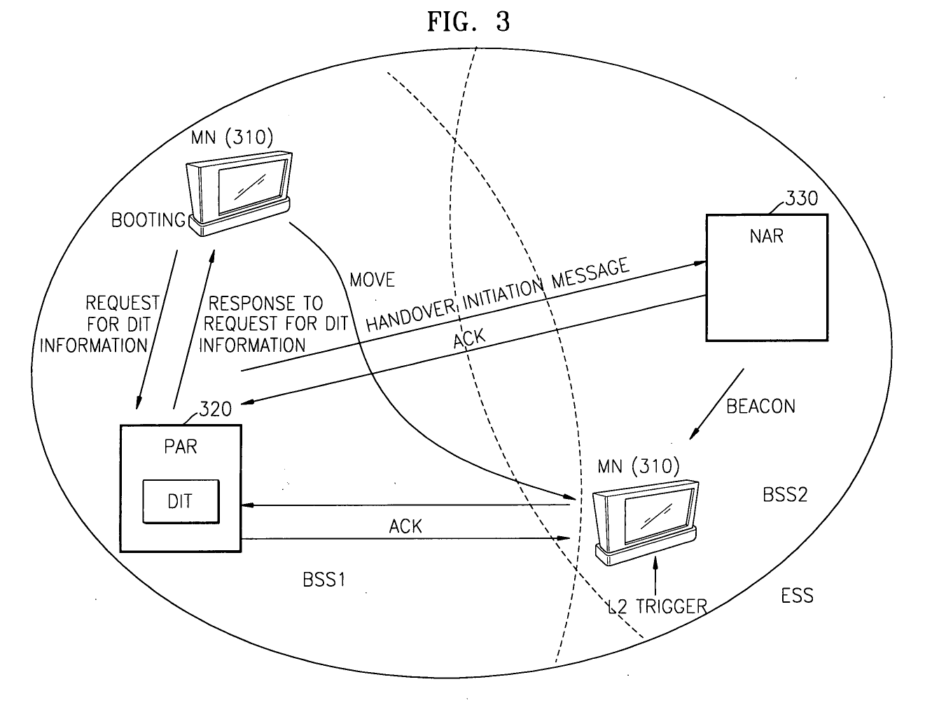

FIG. 3 is a diagram illustrating a fast handover method in a wireless local area network (WLAN) environment, according to an exemplary embodiment of the present invention.

Referring to FIG. 3, when a mobile node 310 moves from BSS1 to BSS2, an L2 trigger occurs in BSS2. According to the present invention, the mobile node 310 multicasts a DIT information requesting message to an access router (PAR) 320 of BSS1 when it is booted in BSS1. Then, the PAR 320 transmits a DIT information response message to the mobile node 310 in response to the reception of the DIT information requesting message, and the mobile node 310 stores DIT information received from the PAR 320. Then, when the L2 trigger occurs, the mobile node 310 can identify BSSID of a new access router (NAR) 330. Thereafter, the mobile node 310 obtains prefix information of the NAR 330 by searching the DIT information for the identified BSSID. The mobile node 310 creates a care-of-address using the prefix information of the NAR 330 and carries out a binding update using the created care-of-address. Transmissions of a handover initiation message and an ACK message between the PAR 320 and the NAR 330 are the same as their counterparts in the prior art.

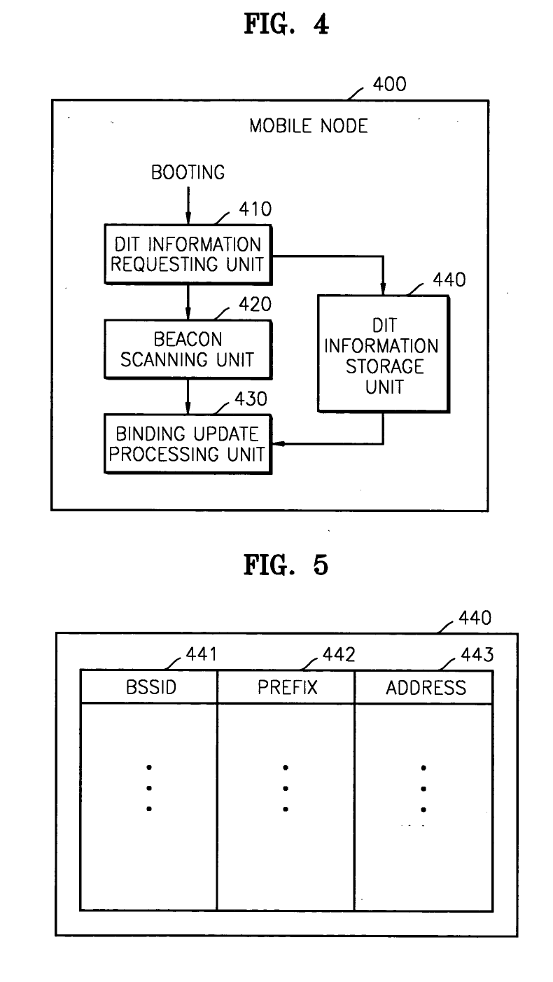

FIG. 4 is a block diagram of a mobile node 400 according to an exemplary embodiment of the present invention. The mobile node 400 includes a DIT information requesting unit 410, a beacon scanning unit 420, a DIT information storage unit 440, and a binding update processing unit 430. The DIT information requesting unit 410 issues a request for DIT information to an access router of a BSS that the mobile node 400 currently belongs to. The beacon scanning unit 420 scans a beacon signal transmitted from the access router. The DIT information storage unit 440 stores the DIT information input thereinto. When an L2 trigger occurs, the binding update processing unit 430 creates a care-of-address using prefix information of a new access router, stored in the DIT information storage unit 440 and sends a binding update message to a previous access router using the created care-of-address.

A data table stored in the DIT information storage unit 440 of FIG. 4 is illustrated in FIG. 5. DIT information includes BSSID information 441, prefix information 442, and address information 443. The address information 443 includes a link layer address and an IP address.

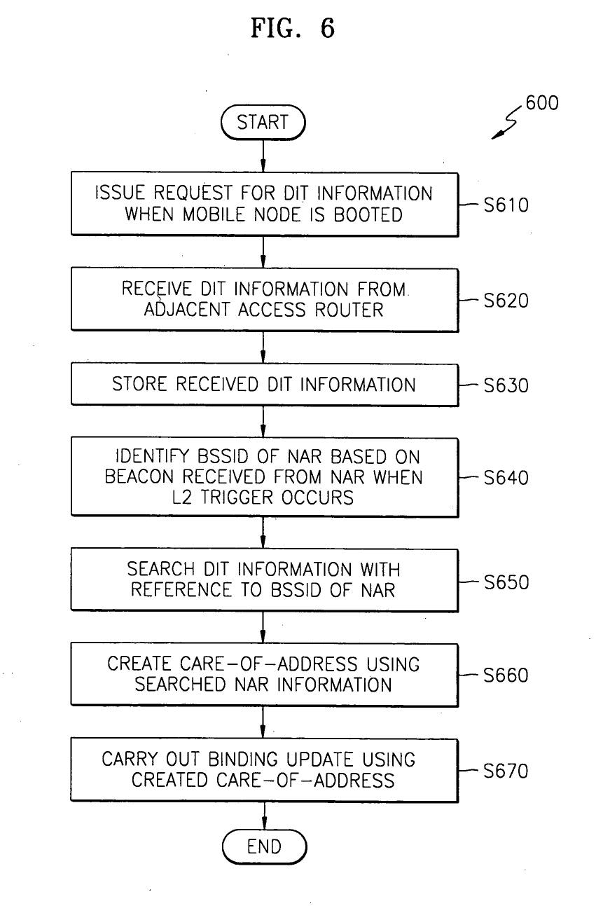

FIG. 6 is a flowchart of a handover method in a WLAN environment according to an exemplary embodiment of the present invention.

Referring to FIG. 6, when the mobile node 400 of FIG. 4 is booted, the DIT information requesting unit 410 of the mobile node 400 multicasts a message requesting DIT information to an access router of a BSS that the mobile node 400 currently belongs to, in step S610.

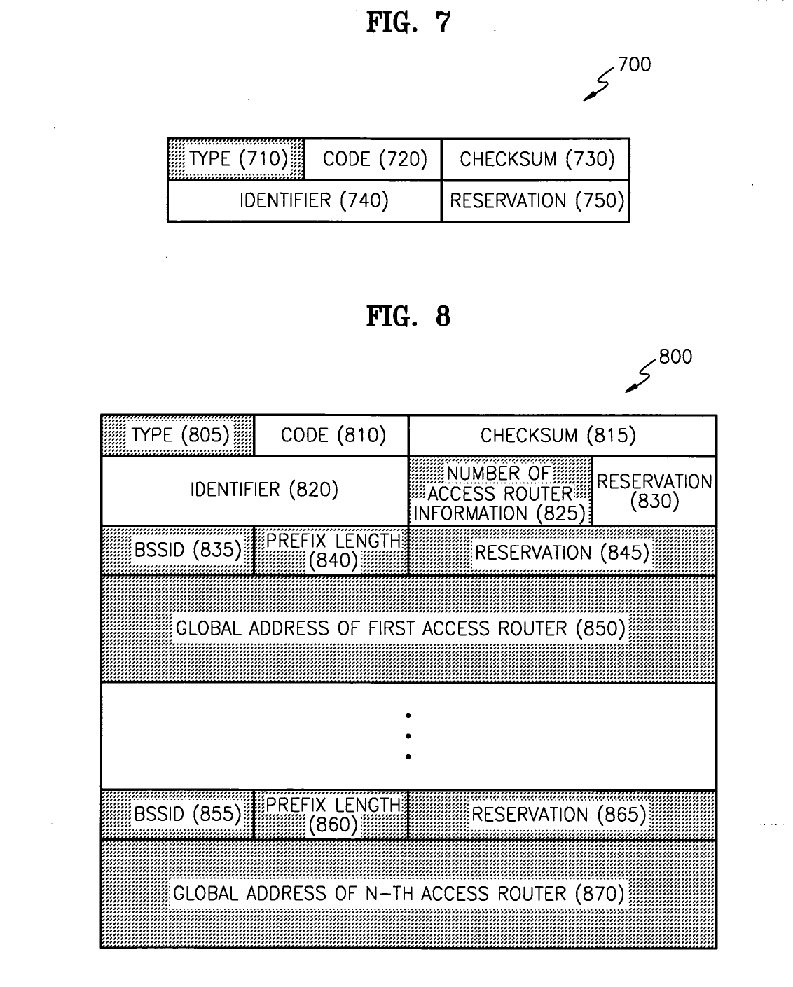

An example of an Internet Control Message Protocol (ICMP) message containing a request for DIT information is illustrated in FIG. 7.

ICMP, which is part of an IP layer, presents an error message and information on a predetermined state that needs to be watched carefully. In general, an ICMP message is used by the IP layer or a higher protocol.

A DIT information requesting message 700 includes a type field 710 which indicates a certain type of ICMP message, a code field 720 which may have different values for certain types of status, a checksum field 730, an identifier field 740 which is provided for differentiating the DIT information requesting message 700 from other messages, and a reservation field 750.

The standards regarding the ICMP messages define 15 different types of ICMP messages using the type field 710. In the present invention, the type field 710 is set to an arbitrary value that is currently not used in the standards in order to differentiate the DIT information requesting message 700 from other ICMP messages.

An access router which receives the DIT information requesting message 700 searches its DIT information and sends requested DIT information to the mobile node 400 in step S620.

An example of a DIT information response message created by the access router to send the requested DIT information to the mobile node 400 is illustrated in FIG. 8.

A DIT information response message can be an IPv6 ICMP message. As shown in FIG. 8, a DIT information response message 800 includes a type field 805, a code field 810, a checksum field 815, an identifier field 820, a number field 825 which indicates the number of pieces of access router information to be contained in the DIT information response message 800, and a reservation field 830. In addition, the DIT information response message 800 contains a BSSID field 835, a prefix length field 840, a reservation field 845, and a first access router's global address field 850 as pieces of information on a first access router. The DIT information response message 800 also contains a BSSID field 855, a prefix length field 860, a reservation field 865, and an n-th access router's global address field 870 as pieces of information on an n-th access router. The type field 805 is set to an arbitrary value that is currently not used in the standards in order to differentiate the DIT information response message 800 from other ICMP messages.

Thereafter, in step S630, the mobile node 400 stores DIT information, prefix information, and address information received from an access router in the DIT information storage unit 440.

Thereafter, if an L2 trigger occurs in the mobile node 400, the beacon scanning unit 420 receives a beacon message from a new access router (NAR) and identifies BSSID information of the NAR in step S640.

In step S650, the mobile node 400 obtains prefix information (442) of the NAR by searching the DIT information stored in the DIT information storage unit 440 with reference to the identified BSSID information of the NAR.

In step S660, the binding update processing unit 430 creates a care-of-address using the prefix information of the NAR. In other words, the mobile node 400 creates the care-of-address using its own MAC address and the prefix information of the NAR among pieces of the DIT information that have already been stored in the DIT information storage unit 440 before the L2 trigger occurs.

In step S670, the mobile node 400 transmits a binding update message to the PAR using the created care-of-address.

Then, the PAR responds to the reception of the binding update message by sending an ACK message to the mobile node 400 and transmits a handover initiation message to the NAR. In response to the reception of the handover initiation message, the NAR transmits an ACK message to the PAR.

According to the present invention, it is possible to reduce handover latency by obtaining information on a new access router when a mobile node is booted.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A handover method in a wireless local area network (WLAN) environment, comprising:
a) issuing a request for network information on access routers, to an access router of a Basic Service Set that a mobile node belongs to when booted;
b) receiving the network information from the access router and storing the network information as stored network information; and
c) performing a binding update using the stored network information.

2. The handover method of claim 1, wherein in the issuing the request, the request for the network information is issued by multicasting an Internet Control Message Protocol (ICMP) message having a type field representing the request for the network information.

3. The handover method of claim 1, wherein the receiving the network information comprises:
receiving an Internet Control Message Protocol (ICMP) message having a type field representing a response to the request for the network information from the access router.

4. The handover method of claim 1, wherein in the receiving the network information, the network information includes the Basic Service Set Identification information, prefix information, and address information of the access router.

5. The handover method of claim 1, wherein the performing the binding update comprises:
identifying Basic Service Set Identification information of a new access router based on a beacon signal received from the new access router when an L2 trigger occurs;
obtaining prefix information of the new access router by searching the stored network information for the Basic Service Set Identification information of the new router;
creating a care-of-address using the prefix information of the new access router and a media access control (MAC) address of the mobile node; and
transmitting a binding update message using the care-of-address.

6. A handover apparatus in a Wireless Local Area Network (WLAN) environment, comprising:
a network information requesting unit which issues a request for network information on access routers, to an access router of a Basic Service Set that a mobile node belongs to when booted;
a network information storage unit which stores the network information received from the access router; and
a binding update processing unit which carries out binding update using the network information.

7. The handover apparatus of claim 6, wherein the network information requesting unit multicasts an Internet Control Message Protocol (ICMP) message having a type field representing the request for the network information.

8. The handover apparatus of claim 6, wherein the network information received from the access router is contained in an Internet Control Message Protocol (ICMP) message having a type field representing a response to the request for the network information.

9. The handover apparatus of claim 6, wherein the network information stored in the network information storage unit includes the Basic Service Set Identification information, prefix information, and address information of the access router.

10. The handover apparatus of claim 6, wherein when an L2 trigger occurs, the binding update processing unit identifies Basic Service Set Identification information of a new access router based on a beacon signal received from the new access router, obtains prefix information of the new access router by searching the stored network information for the Basic Service Set Identification information of the new access router, creates a care-of-address using the prefix information of the new access router and an MAC address of the mobile node, and transmits a binding update message using the care-of-address.

11. An Internet Control Message Protocol (ICMP) message used in a Wireless Local Area Network (WLAN) environment, comprising:
a type field which indicates a request for network information on access routers, to an access router of a Basic Service Set that a mobile node belongs to when booted.

12. An Internet Control Message Protocol (ICMP) message used in a Wireless Local Area Network (WLAN) environment, comprising a type field which indicates a response to a request for network information;
a number field which indicates a number of pieces of access router information to be transmitted; and
an access router information field which indicates information on access routers.

13. The ICMP message of claim 12, wherein the access router information field contains a Basic Service Set Identification information field, a prefix length information field, and a global address information field.

14. The handover method of claim 1, wherein the network information is a distributed information table (DIT) information.

15. The handover apparatus of claim 6, wherein the network information is a distributed information table (DIT) information.

16. The ICMP message of claim 11, wherein the network information is a distributed information table (DIT) information.

17. The ICMP message of claim 12, wherein the network information is a distributed information table (DIT) information.
